(19) United States
(12) Patent Application Publication
(10) Pub. No.: US 2010/0187802 A1
(43) Pub. Date: Jul. 29, 2010

(54) LOOSE LEAF PAGES SUITABLE FOR BINDING

(75) Inventors: Carlos Katzman, Jerusalem (IL); Udi Katzman, Jerusalem (IL)

Correspondence Address: THE NATH LAW GROUP, 112 South West Street, Alexandria, VA, 22314, US

(73) Assignee: MEMADOR LTD., Jerusalem (IL)

(21) Appl. No.: 12/665,906

(22) PCT Filed: Dec. 18, 2008
(86) PCT No.: PCT/IL08/00826

§ 371 Date: Mar. 12, 2010

Related U.S. Application Data
(60) Provisional application No. 60/929,274, filed on Jun. 20, 2007.

(51) Int. Cl. B42D 1/08; B42D 5/00

(52) U.S. Cl. 281/22; 281/38

(57) ABSTRACT

The invention provides a loose leaf page for use in a binder such as an album, scrap book, and the like. The loose leaf page of the invention has a display panel and a binding panel. The binding panel is spaced apart from the display panel. The display panel and the binding panel are coated with a substantially transparent sheet that maintains the integrity of the page despite the space between the display and binding panels, and protects graphical content on the page from being scratched and other types of damage. The invention also provides a method for making the loose leaf page of the invention as well as an album, scrapbook and the like comprising the loose leaf pages of the invention.

### FIELD OF THE INVENTION

This invention relates to loose leaf pages and to methods of their manufacture.

### BACKGROUND OF THE INVENTION

Loose leaf binding is utilized in such articles as albums, scrapbooks, notebooks, and booklets. The loose leaves are typically bound using binding cloth and then sewn into a cover, or they may be bound using a spiral or screws passing through holes punched through the leaves. A common problem of existing binding techniques for such leaves is tearing around the binding region and other damage caused through repeated turning of the page.

Various types of loose leaf binding techniques are known. For example, in U.S. Pat. No. 6,746,050, a loose leaf is disclosed having a strip-shaped part firmly attached to an edge of the loose leaf which is suppler than the leaf material.

U.S. Pat. No. 5,403,138 is directed to a booklet album including a stack of double-sided photographs. Each double-sided photograph includes two photoprints, which are laminated with one transparent sheet on their front surface. The laminated sheets are folded between the photoprints.

### SUMMARY OF THE INVENTION

In one of its aspects, the present invention provides a loose leaf page suitable for binding. The loose leaf pages of the invention may be bound together, for example, into an album, scrapbook, booklet or notebook. The loose leaf page of the invention has a display panel suitable for displaying graphical material, and a binder panel adapted to receive a binding member when the pages are stacked and bound together. The display panel is spaced apart from the binding panel by an intervening gap. A surface laminate forms an outer layer on at least one surface of the page and maintains the integrity of the page, despite the gap between the two panels. The surface laminate overlies the graphic content and thus protects it from being scratched and other forms of damage.

In another of its aspects, the invention provides a method for producing the loose leaf page of the invention. Graphical content is applied to the display portion of a page blank on at least one of its surfaces. The display portion is enclosed within two transverse margins and a lateral edge forming a longitudinal margin which will form the binding panel. Along part of the first longitudinal margin, a slot is formed to separate the display section from the binding panel while maintaining the integrity of the page blank by means of the transverse margins. The page is then laminated with a laminating material on one or both of its sides over the display section, the slot and at least part of the binding panel. The transverse margins are then cut off to leave the display section spaced apart from the binding panel, where the integrity of the page is maintained by the laminate. The laminating material may be transparent or translucent.

In yet another of its aspects, the invention provides an album, scrapbook or the like comprising one or more loose leaf pages of the invention.

Thus, in one of its aspects a loose leaf page comprising a display panel and a binding panel, the binding panel being spaced apart from the display panel, wherein, at least the portion of the display panel and at least a portion of the binding section are coated with a laminating sheet and the display panel and the binding panel are maintained in the spaced apart arrangement by the laminating sheet.

In another of its aspects, the invention provides a method for producing a loose leaf page with an integrated flexible section, the method comprising the steps of:
(a) providing a page blank having a display panel, a binding panel, and at least one of a top margin and a bottom margin, the binding panel being spaced apart from the display panel by an intervening section of the page blank;
(b) removing the intervening section while maintaining the integrity of the page blank;
(c) coating at least a portion of the binding panel and at least a portion of the display panel with a laminating sheet; and
(d) removing one or both of the top margin and the bottom margin so that the binding panel and a display panel are spaced apart and connected by the laminating sheet.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 shows a front view of an album page in accordance with one embodiment of the invention;

FIG. 2a-2b shows a back view of the album page of FIG. 1;

FIGS. 3a-3e show successive steps in the production of an album page according to an embodiment of the present invention;

FIG. 4 shows an album in a closed configuration comprising a plurality of album pages of FIGS. 1 to 3 that are bound together through a binding section of each page;

FIG. 5 shows the album of FIG. 4 in an open configuration:

FIG. 6 shows a rolled-up sheet of page blanks for the production of loose-leaf pages of the invention by web printing; and

FIG. 7a-7f shows production of a loose-leaf page by web printing, in accordance with one embodiment of the invention.

### DETAILED DESCRIPTION OF EMBODIMENTS

In the following, the invention will be described with reference to an album page. This is only for the sake of clarity in the description. It being evident that the invention may be applied to other loose-leaf pages such as loose leaf pages for binding into a scrapbook, booklet or notebook.

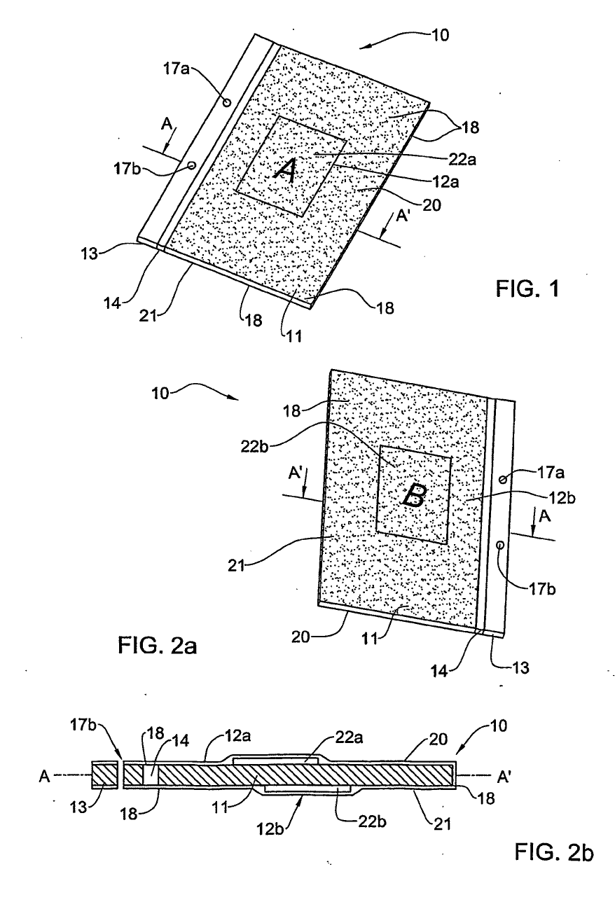

FIGS. 1 and 2 show an album page, generally designated 10, in accordance with one embodiment of this aspect of the invention. The album page 10 has a first surface 20 best seen in FIG. 1 and a second surface 21 best seen in FIG. 2. The album page 10 includes a display panel 11 and a binder panel 13. The display 11 and binding 13 panels are formed from a stiff material such as cardboard or a similar material. The display panel 11 bears thereupon graphic content 22a and 22b such as picture or text. Each of the first 20 and second 21 surfaces of the display panel 11 includes a respective display section 12a and 12b. The graphic content 22a and 22b may be printed directly onto the display section 12a and 12b or may first be printed on a separate medium and then attached to the display section 12a and 12b by means of adhesive.

The page 10 further comprises a preferably transparent surface laminate 18 (indicated by stippling in FIGS. 1, 3, and 7) that forms an outer layer on each of the two surfaces 20 and 21. The surface laminate 18 is adhered to the display 11 and binding 13 panels by means of a preferably transparent adhesive. The surface laminate 18 overlies the graphic content 22a and 22b and thus protects it from being scratched and other forms of damage. The binding panel 13 is provided with through-going apertures 17a and 17b adapted to receive a binding member when several of such pages 10 are stacked and bound together. The display panel 11 is spaced apart from the binding panel 13 by an intervening gap 14. The surface laminate 18 thus maintains the integrity of the page 10, despite the gap 14, between display 11 and binding 13 panels.

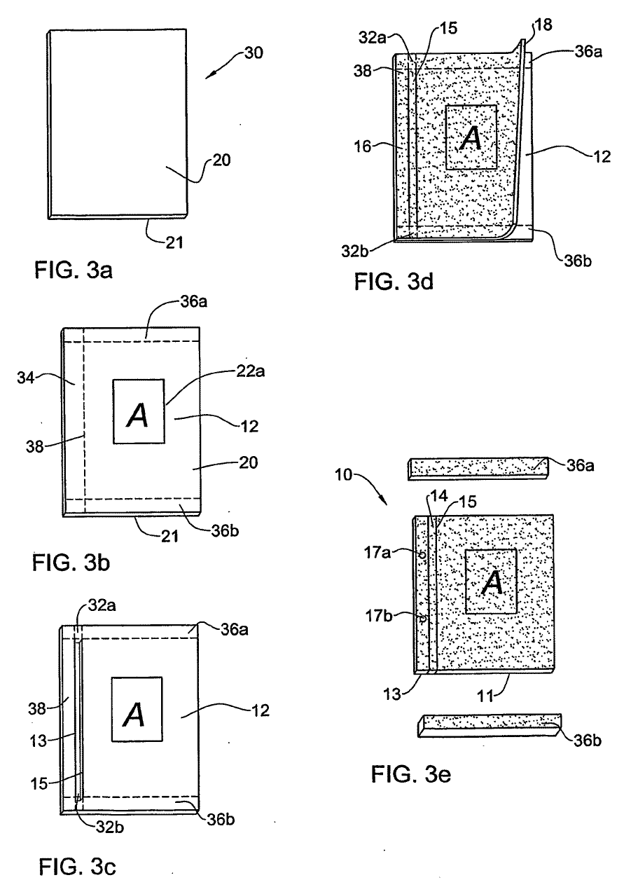

Attention is now drawn to FIGS. 3a-3e, which show a method for forming the page 10 in accordance with one embodiment of this aspect of the invention. A page blank generally designated 30 made from a stiff material such as cardboard is provided (FIG. 3a). Graphic content 22a is applied to the display portion 12 of the page blank 30 on at least one of the surfaces 20 and 21 of the blank 30 (FIG. 3b).

The display panel 12 is enclosed within two transverse margins 36a and 36b and a lateral edge 34 forming a longitudinal margin 38 which will form the binding panel 13 (see FIG. 3e). The transverse margins and lateral edges may or may not be demarcated on the page blank. Optionally, the display panel 12 can be enclosed by two transverse margins 36a and 36b in the blank 30 and two longitudinal margins (not shown). The margin can have printed thereon information such as a page number, a serial number of a client order etc. which as shown below, is removed upon completion of the manufacture process.

As illustrated in FIG. 3c, along part of the first longitudinal margin 38, a longitudinal slot 15 is formed to separate the display section 12 from the binding panel 13. The slot 15 is bounded by the display section 12, part of the longitudinal margin 38, and two connecting areas 32a and 32b being part of the transversal margins 36a and 36b, respectively.

The page is then laminated with a laminating material 18 on one or both sides (shown in FIG. 3d), preferably covering most of each side of the page, including the display section 12, the slot 15 and at least part of the binding panel 13. The transverse margins 36a and 36b including the connecting areas 32a and 32b between the display section 12 and the binding panel 13 are then cut off to leave the display section 12 spaced apart from the binding panel 13 by the layer of laminating material 18, forming an integral flexible portion 14 (as shown in FIG. 3e).

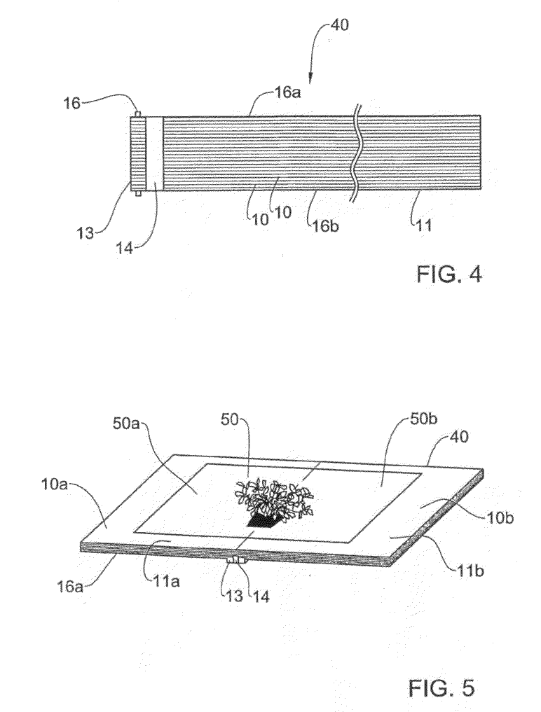

Thus, as shown in FIG. 3e, the completed album page 10 in accordance with the specific embodiment of the present invention has the display section 12 and the binding panel 13 spaced apart from each other by the integral flexible portion 14. The integral flexible portion 14 according to this embodiment is formed by transparent laminating sheet 18. The binding panel 13 of the display page 10 as illustrated in FIG. 3e is then provided with two apertures 17a and 17b that are positioned and dimensioned to receive a binding member when several of such display pages are stacked together to form a bound album 40 as can be seen in FIG. 4.

The loose-leaf page of the invention may be produced in a process of web printing. As shown in FIG. 6, in web printing an elongated sheet 62, comprising two or more page blanks 60 that are initially joined together, is used. The sheet 62 may be initially rolled up, as shown in FIG. 6. A page blank 60a, for example is integral with a page blank 60b at the left and right lateral edges of the pages 60a and 60b, respectively, to form a border 64a between the two page blanks that may or may not be demarcated in the sheet 62. The page blank 60b, in turn, is integral with a page blank 60c at the left and right lateral edges of the pages 60b and 60c, respectively, to form a border 64b.

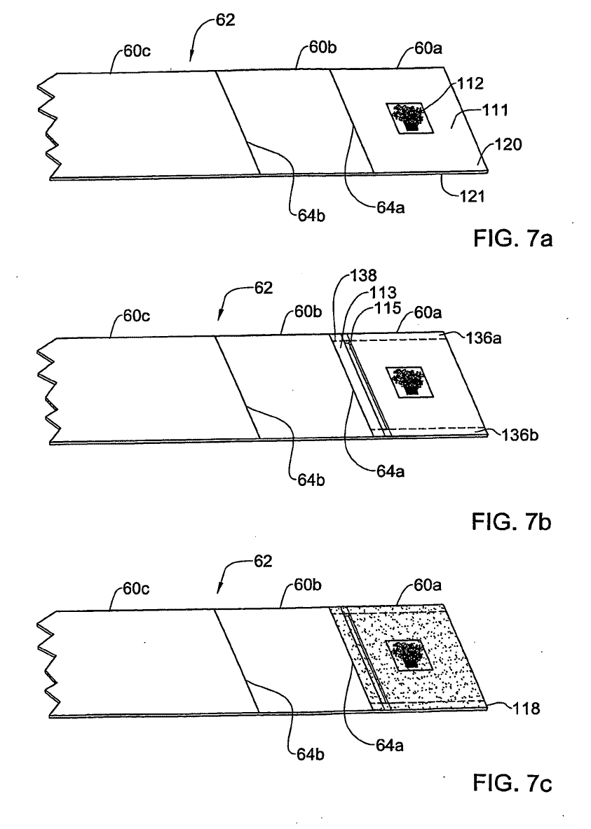

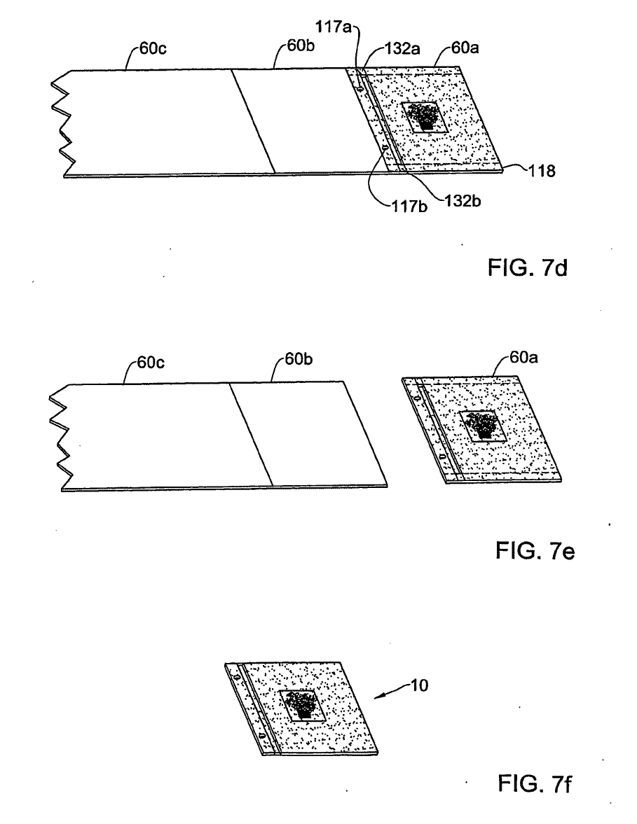

FIG. 7 shows a method for producing a loose-leaf page in accordance with the invention by web printing. In this process, the page blanks, 60a, 60b, 60c, etc. are processed sequentially. The page blank 60a is processed first. In FIG. 7a, graphic content 112 is applied to the display panel 111 of the page blank 60a of at least one of the surfaces 120 and 121 of the blank 60a. As illustrated in FIG. 7b, a longitudinal slot 115 is formed to separate the display panel 111 from a binding panel 113. The slot 115 is bounded by the display panel 111, part of the longitudinal margin 138, and two connecting areas 32a and 32b being part of the transversal margins 136a and 136b, respectively.

The page 60a is then laminated with a laminating material 118 on one or both sides (shown in FIG. 7c), preferably covering most of each side of the page, including the display panel 111, the slot 115, and at least part of the binding panel 113. The binding panel 113 of the display page 60a as illustrated in FIG. 7d is then provided with two apertures 117a and 117b that are positioned and dimensioned to receive a binding member when several of such display pages are stacked together to form a bound album as described below. The page blank 60a is then detached from the sheet 62 by cutting the sheet 62 along the boundary 64a. The transverse margins 136a and 136b of the page blank 60a, including the connecting areas 132a and 132b between the display panel 12 and the binding panel 13 are then cut off to leave the display panel 112 spaced apart from the binding panel 113 with the layer of laminating material 118 forming an integral flexible portion 14 (as shown in FIG. 7f). The process can then be repeated sequentially for the page blanks 60b, 60c, etc.

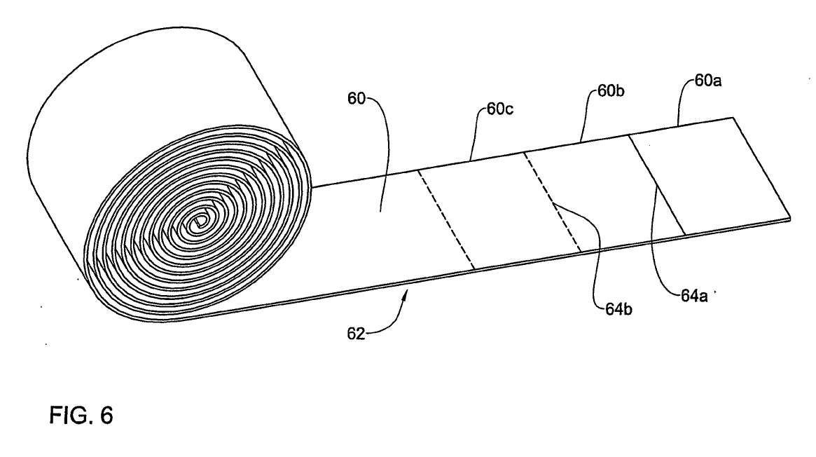

FIGS. 4 and 5 show an album, generally designated 40, according to the present invention. The album 40 is shown closed and in a side view in FIG. 4 and is shown open and in a perspective in FIG. 5. The album 40 comprises several album pages 10 of the present invention, such as the pages 10a and 10b, and a front cover 16a and a back cover 16b. The pages and covers are bound together with a binding member such as screws 16 or any other binding element known to a person skilled in the art through the apertures 17a and 17b to form the bound album 40. The integral flexible portion 14 serves as a hinge region of the pages 10 so that the pages can be turned to view the graphic content printed thereon, without bending the display panels 11a and 11b of the pages 10a and 10b, respectively, or the binding panels 13, and thus reducing or preventing damage to either panel as well as to the graphic content printed on the page.

When bringing two adjacent album pages 10a and 10b in the album 40 from a closed position, in which the graphic content of the two adjacent pages face each other, to an open position, in which the graphic content of the two adjacent pages is revealed, the display portion of each of the two adjacent pages are juxtaposed as shown in FIG. 5, without the binding panel 13 or the gap 14 intervening between them. Thus, graphic content such as a single photo 50 may be divided into two portions 50a and 50b and mounted as a spread on the two adjacent pages (see FIG. 5) and viewed as a single integral graphical unit.

Whilst some embodiments have been described and illustrated with reference to some drawings, the artisan will appreciate that many variations are possible which do not depart from the general scope of the invention, mutatis, mutandis.

1. A loose-leaf page comprising
a display panel and a binding panel, the binding panel being spaced apart from the display panel,
wherein at least a portion of the display panel and at least a portion of the binding panel are coated with a laminating sheet, and the display panel and the binding panel are spaced apart and separated by a flexible region formed by the laminating sheet.

2. The loose-leaf page according to claim 1, wherein the laminating sheet is transparent.

3. The loose-leaf page according to claim 1, wherein the laminating sheet is attached to one or both of the binding panel and the display panel by an adhesive.

4. The loose-leaf page according to claim 1, wherein the laminating sheet is applied to at least one side of the loose-leaf page.

5. The loose-leaf page according to claim 4, wherein the laminating sheet is applied to both sides of the display panel.

6. The loose-leaf page according to claim 1, wherein the laminating sheet overlies graphic material mounted on the display panel.

7. An album, notebook, or scrapbook comprising one or more loose-leaf pages according to claim 1.

8. The album, notebook, or scrapbook of claim 7, wherein the loose-leaf pages are bound together at the binding panel of each page.

9. The album, notebook, or scrapbook of claim 8, wherein the binding panel of each page is provided with one or more apertures, and the album comprises one or more binding members, each binding member passing through one or more of the apertures.

10. The album, notebook, or scrapbook according to claim 7, further comprising one or both of a front cover and a back cover.

11. A method for producing a loose leaf page comprising the steps of:
(a) providing a page blank having a display panel, a binding panel, and at least one of a top margin and a bottom margin, the binding panel being spaced apart from the display panel by an intervening section of the page blank;
(b) forming a slot in the intervening section while maintaining the integrity of the page blank;
(c) applying to at least a portion of the binding panel and at least a portion of the display panel a flexible laminating sheet; and
(d) removing one or both of the top margin and the bottom margin so that the display panel is separated from the binding panel by a flexible region comprising the laminating sheet.

12. The method according to claim 11 further comprising applying graphic material to one or more surfaces of the display panel prior to application of the laminating sheet.

13. The method of claim 11, wherein the binding panel is provided with one or more apertures adapted to receive a binding member therethrough.

14. The method according to claim 11, wherein the laminating sheet is transparent.

15. The method according to claim 11, wherein one or more loose-leaf pages are produced by a method of web printing.
